(19) United States
(12) Patent Application Publication
(10) Pub. No.: US 2007/0033558 A1
(43) Pub. Date: Feb. 8, 2007

(54) Method and system for reshaping metal wires in VLSI design

(75) Inventors: O. Sam Nakagawa, Redwood City, CA (US); Andrew B. Kahng, Del Mar, CA (US)

Correspondence Address: STAINBROOK & STAINBROOK, LLP, 3558 ROUND BARN BLVD., SUITE 203, SANTA ROSA, CA, 95403, US

(73) Assignee: BLAZE-DFM, INC., SUNNYVALE, CA (US)

(21) Appl. No.: 11/199,900

(22) Filed: Aug. 8, 2005

(51) Int. Cl. G06F 17/50

(52) U.S. Cl. 716/5

(57) ABSTRACT

A method and system for representing metal wires in Very Large Scale Integration (VLSI) circuit design in a simplified form. A pair of metal wires is considered at a time. A plurality of Piece Wise Linear (PWL) equations is created to represent sides each of the pair of metal wires. The plurality of PWL equations is used to determine an equivalent coupling capacitance of the pair of metal wires. The pair of metal wires is reshaped to form a pair of reshaped metal wires that are electrically equivalent.

### BACKGROUND OF THE INVENTION

1. Field of the Invention

The present invention relates generally to the field of Very Large Scale Integration (VLSI) circuits. More specifically, it relates to the reshaping of metal wires used in VLSI circuits after Optical Proximity Correction to facilitate RC extraction.

2. Description of the Related Art

Optical Proximity Correction (OPC) is a process for compensating for non-ideal lithography processes. Lithography processes are used to transfer a VLSI circuit design onto a semiconductor wafer. OPC applies systematic changes to photomask geometries to compensate for non-linear distortions caused by optical diffraction and resist process effects. Specifically, these distortions include line-width variations dependent on pattern density which affect a device's speed of operation and line-end shortening which can break connections to contacts. Causes include reticle pattern fidelity, optical proximity effects, and diffusion and loading effects during resist and etch processing. OPC is used to alter the shapes put down on the lithography mask that negates these undesirable distortion effects during pattern transfer. OPC works by making small changes to the IC layout that anticipate the distortions.

The metal wires obtained after OPC are not rectangular in shape. The metal wires obtained as a result of OPC can have non-orthogonal vertices and can even be curvilinear. The metal wires may also have side wall angle variations and variable height. The metal wires have a resistance and a capacitance value associated with them. These values are determined using a process known as Resistance Capacitance extraction or RC extraction. The process of RC extraction is enabled by software (such as REX, Magic, and the like). The VLSI design provides information related to the size, shape, spacing, and material of the metal wires. This information is input to the software. Based on this information the software calculates the values of RC associated with the metal wires. Though RC extraction may have been performed on the original design of the circuit wires, where OPC has been performed, RC extraction values for the re-formed wires will have changed, and thus RC extraction must be done again in order to calculate the resistance and capacitance values for these new shapes. Conventional chip-level RC extractors, however, are not able to handle metal wires obtained after OPC.

A known method for reshaping wires addresses the problem of shapes of metal wires used in VLSI circuits. The method is related to the stochastic roughness on top surfaces of the metal wires, dealing with a single metal wire at a time. Another method represents each of the metal wires by a plurality of rectangles. This is done by calculating simple line-width averages.

However, the methods discussed above have at least one of the following disadvantages. The methods do not address the side-wall perturbations of metal wires. Also, the methods discussed above deal with a single wire at a time and are unable to provide a system level solution, which considers all the metal wires in a VLSI circuit. Further, since the relationship between coupling capacitance of a pair of metal wires in a VLSI and corresponding spacing is not linear, the methods create reshaped metal wires which are not electrically equivalent. Further, the number of rectangles created to represent each of metal wires may-be very large. The time taken by conventional RC extractors is proportional to the number of coupling surfaces and the complexity of the VLSI design. The more the number of coupling surfaces, more is the time taken for extraction. An increase in the number of rectangles implies an increase in the number of coupling surfaces, and hence the time required for extraction increases. Additionally, the present state of the art requires hash tables to track a pair of reshaped metal wires. Further, there is no provision to skip RC extraction if the shape of the metal wire has not changed significantly after reshaping.

In the light of foregoing discussion, there is a need for a method for representing metal wires during VLSI circuit design in a simplified form so that the process of RC extraction becomes easier and quicker. The method should address the side-wall perturbations of metal wires and provide a system level solution.

### SUMMARY OF THE INVENTION

An objective of the invention is to represent metal wires used in Very Large Scale Integration (VLSI) circuits in a simplified form.

Another objective of the invention is to reduce the time and effort required for Resistance Capacitance (RC) extraction of metal wires from a Geometry Database (GD).

Yet another objective of the invention is to track reshaped metal wires without the use of hash tables.

The present invention provides a method and a system for reshaping metal wires during VLSI circuit design. The method considers a pair of metal wires of a VLSI circuit at a time. A plurality of Piece Wise Linear (PWL) equations representing sides of each of the pair of metal wires is generated. An equivalent coupling capacitance of the pair of metal wires is calculated using the PWL equations. The pair of metal wires is reshaped to form a pair of electrically equivalent reshaped wires.

The system includes a generating module, a calculating module, and a reshaping module. The generating module represents sides of each of the pair of metal wires by a plurality of Piece Wise Linear (PWL) equations. The calculating module determines an equivalent coupling capacitance of the pair of metal wires using the PWL equations. The reshaping module changes shape of each of the pair of metal wires to form a pair of electrically equivalent reshaped wires.

The present invention represents the metal wires in a simplified form and therefore, reduces the time and effort required for RC extraction. Further, the present invention updates the GD by adding data corresponding to the pair of reshaped wires to the GD. The reshaped wires are electrically equivalent and have orthogonal vertices. As a result, the pair of reshaped wires can be tracked without the use of hash tables and RC extraction becomes easier and quicker. In case the difference in widths of the original wires in the VLSI design and the widths of the reshaped wires is not substantial, the process of RC extraction is not repeated.

### BRIEF DESCRIPTION OF THE DRAWINGS

So that the manner in which the above recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a Very Large Scale Integration (VLSI) circuit, in accordance with an embodiment of the invention.

FIG. 2 is a flow chart depicting a method to reshape a pair of metal wires, in accordance with an embodiment of the invention.

FIG. 3 illustrates a method to divide the pair of metal wires into a plurality of pair of Piece Wise Linear (PWL) sections, in accordance with an embodiment of the invention.

FIG. 4 illustrates a method to determine a coupling capacitance of each of the plurality of pair of PWL sections, in accordance with an embodiment of the invention.

FIG. 5 illustrates a method to replace the pair of metal wires by a pair of rectangles, each having area equal to the corresponding polygons, in accordance with an embodiment of the invention.

FIG. 6 is a flow chart depicting a method to determine a value of effective spacing (Se) for the pair of metal wires, in accordance with an embodiment of the invention.

FIG. 7 illustrates a system for reshaping the pair of metal wires, in accordance with an embodiment of the invention.

FIG. 8 is a block diagram illustrating a generating module, in accordance with an embodiment of the invention.

FIG. 9 is a block diagram illustrating a calculating module, in accordance with an embodiment of the invention.

FIG. 10 is a block diagram illustrating a reshaping module, in accordance with an embodiment of the invention.

FIG. 11 illustrates reshaping of metal wires having variable height, in accordance with an embodiment of the invention.

FIG. 12 illustrates reshaping of metal wires having variable side wall angles, in accordance with an embodiment of the invention.

### DETAILED DESCRIPTION OF THE INVENTION

Various embodiments of the present invention provide a method and a system for reshaping metal wires during Very Large Scale Integration (VLSI) circuit design. A pair of metal wires obtained after Optical Proximity Correction (OPC) is considered at a time. The pair of metal wires is converted into a pair of electrically equivalent reshaped wires. It will be apparent to those skilled in the art that the reshaping is done in design space only. Representations of the metal wires are reshaped in accordance with various embodiments of the present invention. The modified shapes are then stored in a Geometry Database (GD). The modified shapes are then used for Resistance Capacitance (RC) extraction. RC extraction using the modified shapes is quicker and easier as the modified shapes have orthogonal vertices. The shape of the actual metal wires of a VLSI, remain as obtained after OPC.

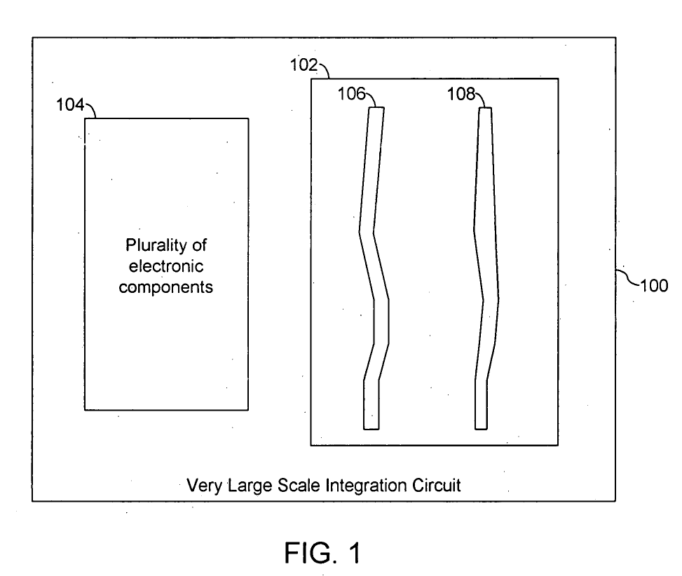

FIG. 1 illustrates a Very Large Scale Integration (VLSI) circuit 100, in accordance with an embodiment of the invention. VLSI circuit 100, which has undergone OPC, includes a pair of metal wires 102 and a plurality of electronic components 104. Pair of metal wires 102 comprises a metal wire 106 and a metal wire 108. Metal wire 106 and metal wire 108 are a representation of metal wires obtained after the process of OPC. It would be apparent to those skilled in the art that metal wire 106 and metal wire 108 represent three-dimensional wires which have a height and may have a non-orthogonal side wall angle. In various embodiments of the invention, the height and the side wall angle may vary.

Further, metal wire 106 and metal wire 108 can be curvilinear or free-form in shape. In such a case, the curvilinear part of metal wire 106 and metal wire 108 can be approximated a series of rectilinear segments (i.e., polygonal shaped). It will be apparent to those skilled in the art that digital computers store and represent curvilinear shapes in the form of a large number of polygonal shapes. This large number of polygons can be used to represent the curvilinear shapes while practicing various embodiments of the present invention.

VLSI is a technology that refers to semiconductor chips that are engineered to accommodate a large number of electronic components—transistors, resistances, capacitances, and the like—on a single chip. For example, in VLSI circuit 100, plurality of electronic components 104 may include one or more transistors, resistances, capacitances, and the like. Metal wire 106 and metal wire 108 provide connectivity to plurality of electronics components 104. Metal wire 106 and metal wire 108 have an associated value of resistance and capacitance.

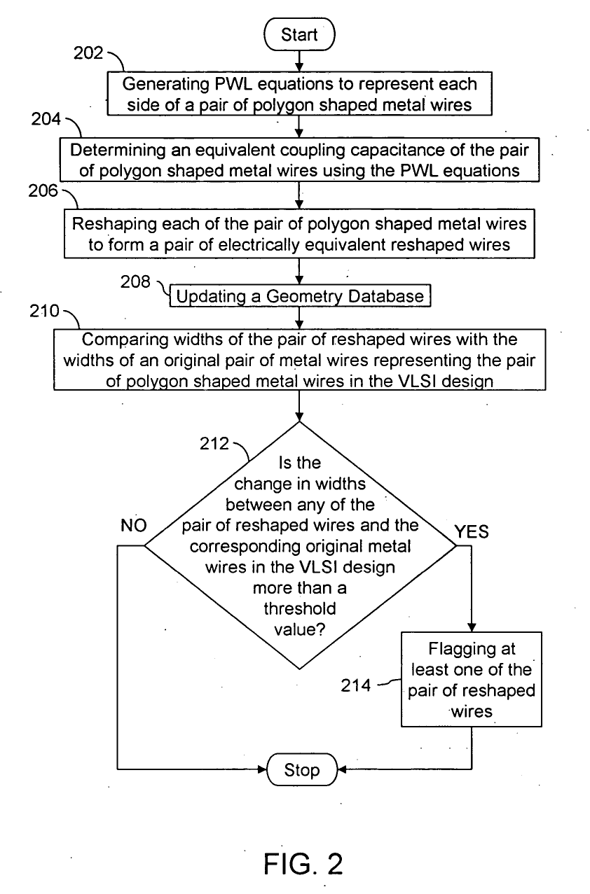

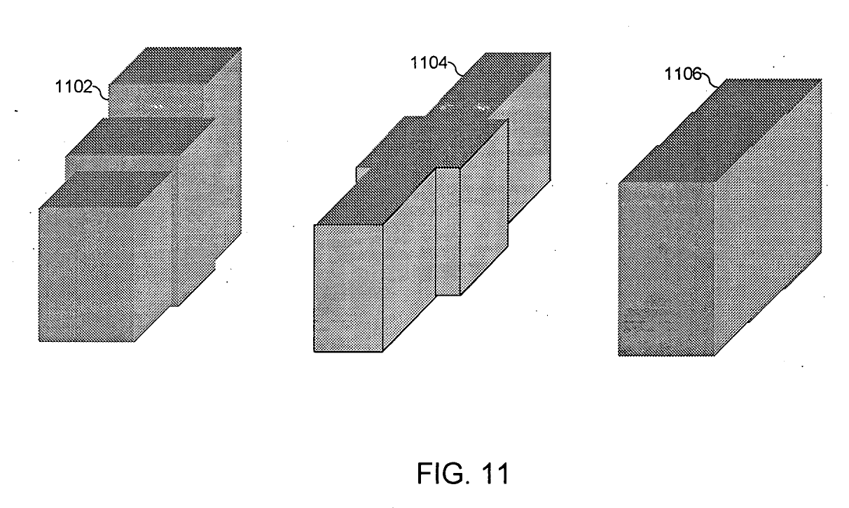

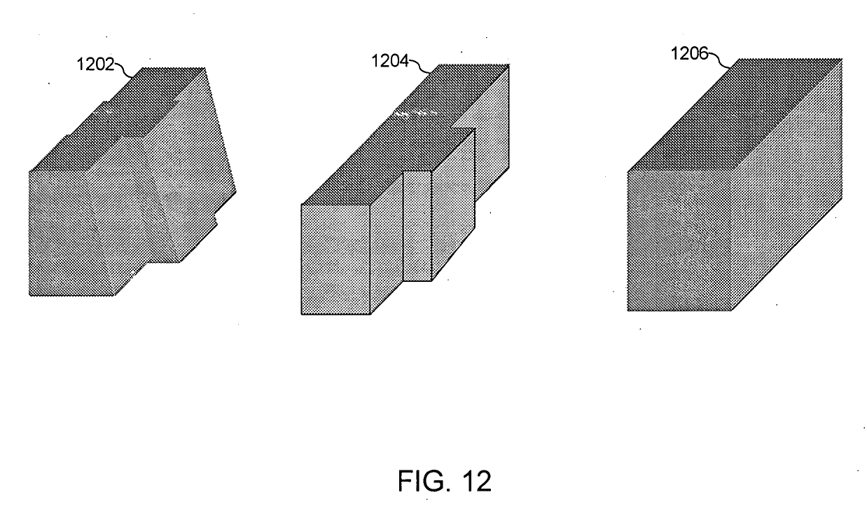

FIG. 2 is a flowchart illustrating a method to reshape pair of metal wires 102, in accordance with an embodiment with the invention. In accordance with an embodiment of the invention, pair of metal wires 102 obtained after OPC are considered to have a unit height and orthogonal side wall angles. In case pair of metal wires 102 has a varying height or a varying side wall angle, the height and the side wall angle are changed to actual values of height and side wall angle as in the original VLSI design for the integrated circuit. This is explained later in conjunction with FIG. 11 and FIG. 12. At step 202, plurality of Piece Wise Linear (PWL) equations are generated to represent sides of metal wire 106 and metal wire 108. At step 204, the plurality of PWL equations are used to determine an equivalent coupling capacitance of pair of metal wires 102. At step 206, each pair of metal wires 102 is reshaped to form a pair of electrically equivalent reshaped wires. The pair of electrically equivalent reshaped wires has equivalent value of coupling capacitance.

In accordance with an embodiment of the present invention, the GD is updated, at step 208. The data related to the shape of the pair of reshaped wires is added to the GD.

In accordance with another embodiment of the present invention, at step 210, widths of the pair of reshaped wires are compared with the widths of an original pair of metal wires in a VLSI design. A difference in widths is calculated based on the comparison. The original pair of metal wires represents metal wires as included in the VLSI design. During the process of Optical Proximity Correction (OPC), the shapes of the original pair of wires are modified to become pair of metal wires 102. In an embodiment of the invention, the corresponding wires in the pairs are compared. At step 212, the difference in the widths between at least one of the pair of reshaped wires and the widths of the original pair of metal wires in the VLSI design is compared with a threshold value. An exemplary threshold value is 0.01 μm. If the difference in widths is more than the threshold value, at least one of the pair of reshaped wires is flagged at step 214. The flagged state of the reshaped pair of wires indicates that at least one of the pair of reshaped wires needs re-extraction. In other words, the flagged state signifies that the process of RC extraction is to be performed on at least one of the pair of reshaped wires.

Where RC extraction has been performed before OPC, and it is determined that the widths of the reshaped wires are similar to the widths of the wires in the original VLSI design, RC extraction need not be performed again. This is because RC values of the reshaped wires will be approximately equal to the RC values of the original VLSI design. However, where wire line widths have significantly changed due to reshaping, RC extraction will need to be performed again. It will be apparent to those skilled in the art that the flagged state is thus an indicator for whether any of the pair of reshaped wires needs re-extraction. Any means of storing this indication can also be used, without departing from the scope of the present invention. The flagged state of the reshaped wires is updated and stored in the GD. On the other hand, if the difference in widths is less than the threshold value, the pair of reshaped wires is not flagged and the resistance and capacitance values need not be extracted.

For example, for an original wire in the VLSI design of width 0.2 μm, the width of corresponding reshaped wire, obtained as a result of PWL reshaping, is calculated to be 0.25 μm, in accordance with various embodiments of the present invention. Since the difference in width is more than a threshold value of 0.01 μm, the reshaped wire is flagged. The flagged state is stored in the GD. The flagged state indicates that RC extraction needs to be performed for the reshaped wire. Conversely, if the width of the corresponding reshaped wire is calculated to be 0.205 μm, the difference in width is less than the threshold value and therefore, RC extraction need not be performed for the corresponding reshaped wire and thus the pair of reshaped wires is not flagged. This is because the difference in values for resistance and capacitance of the reshaped wires and original wires will not be substantial.

Data related to the shape of metal wires is stored in a Geometry Database (GD). For example, the GD can store the data in the form of coordinates of vertices of the polygons representing the metal wires. In accordance with an embodiment of the present invention, data related to the shape of metal wire 106 and metal wire 108 is stored in a GD. The data stored includes vertices of both metal wire 106 and metal wire 108. The vertices of metal wire 106 and metal wire 108 are extracted from the GD. The vertices of metal wire 106 can be represented as (x₁, y₁, x₂, y₂, x₃, y₃, . . . , xₘ, yₙ), wherein the vertices have been represented in co-ordinate form. Similarly, vertices of metal wire 108 can be represented as (x₁, y₁, x₂, y₂, x₃, y₃, xₙ, yₙ). At step 202, the vertices (x₁, y₁, x₂, y₂, x₃, y₃, xₘ, yₙ) of metal wire 106 are transformed into a plurality of PWL equations of the form:
y=y₁+a₁(x−x₁);
y=y₂+a₂(x−x₂);
y=y₃+a₃(x−x₃); etc.
The values of a₁, a₂, and a₃ are given by:
a₁=(y₂−y₁)/(x₂−x₁);
a₂=(y₃−y₂)/(x₃−x₂);
a₃=(y₄−y₃)/(x₄−x₃); etc.

Each of the plurality of PWL equations represents a PWL section of metal wire 106. The plurality of PWL equations represents a PWL surface of metal wire 106 Similarly, PWL surface of metal wire 108 may be represented by a plurality of PWL equations by converting the vertices extracted into a plurality of PWL equations.

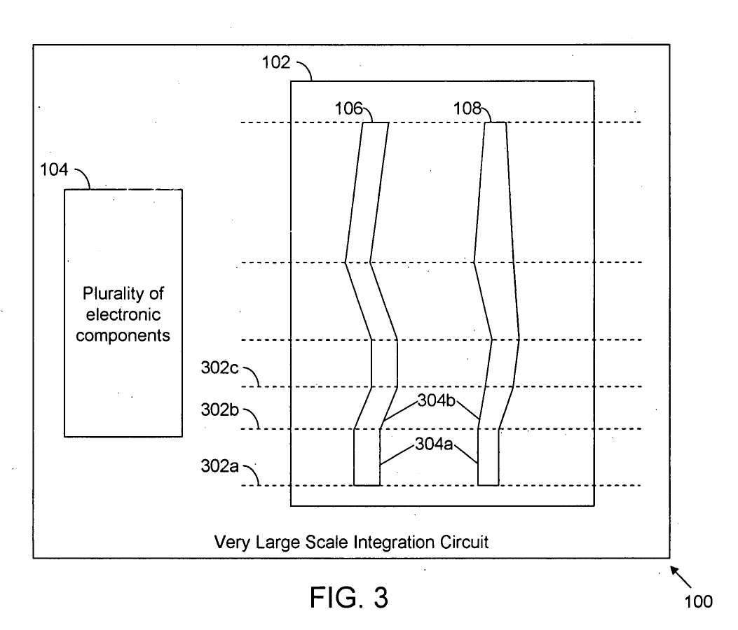

FIG. 3 illustrates division of pair of metal wires 102 into a plurality of pairs of PWL sections 304, in accordance with an embodiment of the invention. Each of plurality of pairs of PWL sections 304 consists of a PWL section on metal wire 106 and a PWL section on metal wire 108. Each of the plurality of bounding lines 302 is an imaginary horizontal line that passes through each of the vertices on the coupling sides of metal wire 106 and metal wire 108 respectively.

A pair of adjoining bounding lines divide the pair of metal wires into a plurality of pair of PWL sections. For example, in VLSI circuit 100, a pair of adjoining bounding lines—bounding line 302a and bounding line 302b—divides pair of metal wires 102 to form a pair of PWL sections 304a. Similarly, bounding line 302b and bounding line 302c form a pair of PWL sections 304b.

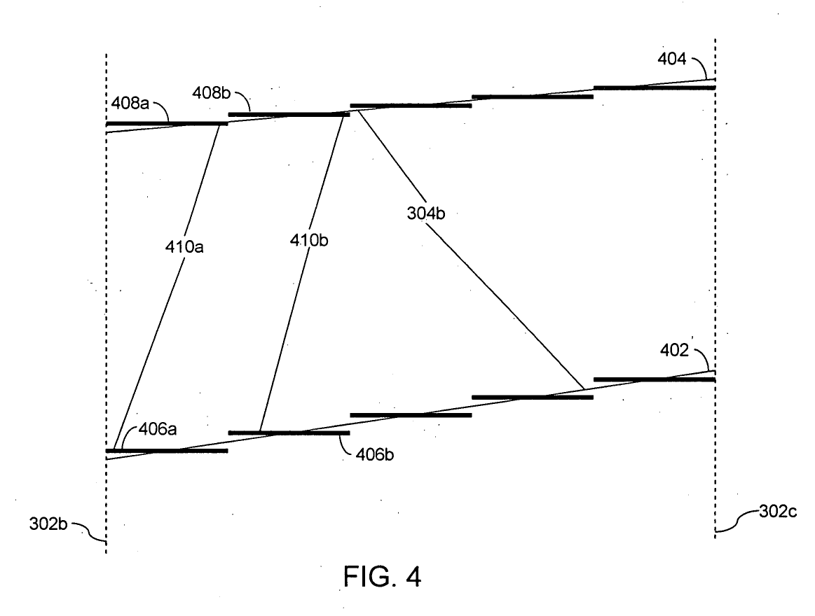

FIG. 4 illustrates a method to determine a coupling capacitance of each of the plurality of pair of PWL sections 304, in accordance with an embodiment of the invention. FIG. 4 shows bounding line 302b, bounding line 302c, and pair of PWL sections 304b. Bounding line 302b and bounding line 302c define pair of PWL sections 304b. Pair of PWL section 304b includes a PWL section 402 and a PWL section 404. PWL section 402 and PWL section 404 are divided into a plurality of micro panels. PWL section 402 is divided into a plurality of micro panels 406. Similarly, PWL section 404 is divided into a plurality of micro panels 408. Micro panel 406a, micro panel 406b, micro panel 408a, and micro panel 408b are shown in FIG. 4. Plurality of micro panels 406 and plurality of micro panels 408 form a plurality of pairs of micro panels 410. A pair of micro panel 410a and a pair of micro panel 410b is shown in FIG. 4. Each of plurality of pairs of micro panels 410 is parallel spaced. For example, micro panel 406a is spaced parallel to micro panel 408a and micro panel 408a is spaced parallel to micro panel 408b.

Values of capacitances for a pair of micro panels are obtained from a lookup table. A lookup table lists values of parallel plate capacitance against spacing. The lookup table also includes fringing components of the capacitance values, which are impacted by the presence of metal wires above and below pair of metal wires 102 in the VLSI circuit design. The sum of the parallel plate capacitance component and the fringing components gives a capacitance value corresponding to a known value of spacing for a pair of parallel plates of a known material. The sum of micro coupling capacitances of each of plurality of pair of micro panels 406 gives the coupling capacitance of PWL section 304b. Further, the sum of capacitances of each of plurality of pairs of PWL sections 304 is an equivalent coupling capacitance of pair of metal wires 102.

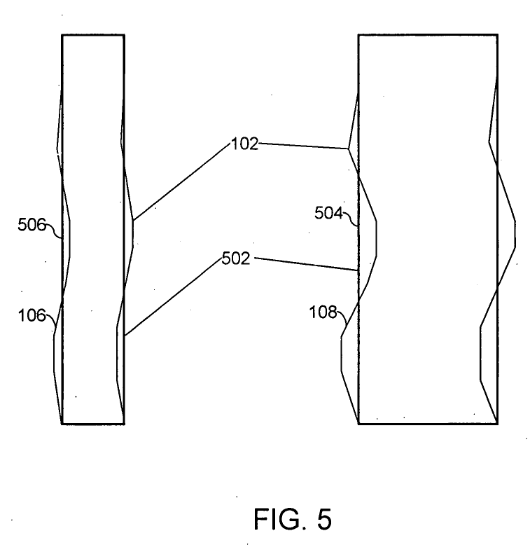

FIG. 5 illustrates a method for replacing pair of metal wires 102 by a pair of rectangles, each having areas equal to the corresponding polygons, in accordance with an embodiment of the invention. FIG. 5 shows metal wire 106, metal wire 108, and a pair of rectangles 502. Pair of rectangles 502 comprises a rectangle 504 and a rectangle 506. Rectangle 506 has length and area equal to metal wire 106. Similarly, rectangle 504 has length and area equal to metal wire 108. The areas of rectangle 506 and rectangle 504 are equal to that of metal wire 106 and metal wire 108 respectively. Further, it will be apparent to those skilled in the art, that the height of each of rectangle 504 and rectangle 506 is equal to corresponding metal wires (metal wire 108 and metal wire 106, respectively), which have been considered to have a unit height. This ensures that the resistance value associated with rectangle 506 and rectangle 504 is equal to the resistance values of metal wire 106 and metal wire 108 respectively.

To determine widths of each of pair of rectangles 502, the width of each of the pair of metal wires 102 is integrated over the corresponding length and the result is divided by the corresponding length. In accordance with an embodiment of the present invention, the integration is done using the plurality of PWL equations.

An area average spacing (Sa) is calculated for pair of metal wires 102. In accordance with an embodiment of the invention, the plurality of PWL equations representing the coupling sides of each of pair of metal wires 102 are used to find the enclosed area between pair of metal wires 102. The enclosed area is divided by the length of rectangle 504 to determine the area average spacing (Sa). The pair of rectangles is then placed at the area average spacing (Sa). For example, pair of metal wires 102 is replaced by a pair of rectangles 502. Pair of rectangles 502 is placed at a spacing equal to the area average spacing corresponding to pair of metal wires 102. Further, as the area of each of pair of rectangles 502 is equal to the corresponding polygons of each of the pair of metal wires 102, resistance and area capacitance of each of pair of rectangles 502 is equal to that of each of pair of metal wires 102.

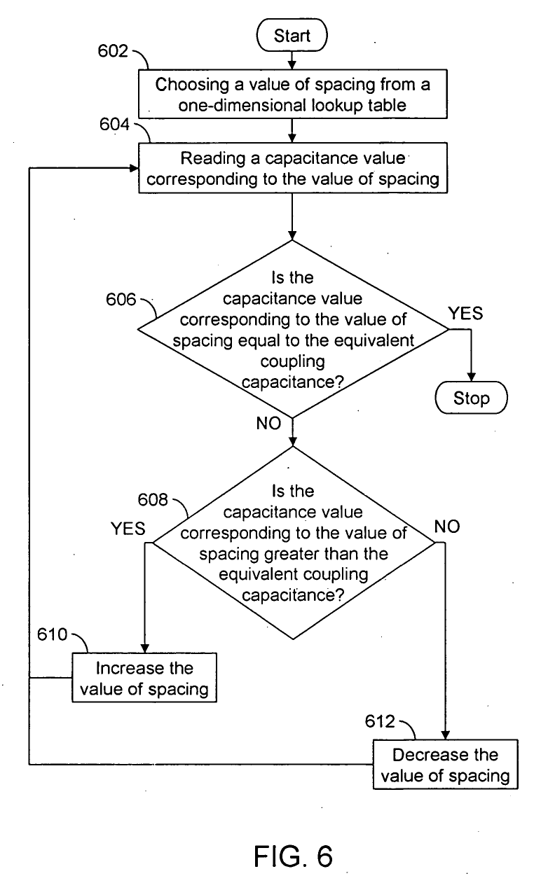

FIG. 6 is a flowchart illustrating a method to determine the value of effective spacing (Se) for pair of metal wires 102, in accordance with an embodiment of the invention. The effective spacing is calculated based on the value of the equivalent coupling capacitance of the pair of metal wires. At step 602, a value of spacing is chosen from the lookup table. Any random value can be chosen. At step 604, a capacitance value corresponding to the value of spacing is read. At step 606, it is checked whether the capacitance value read is equal to the equivalent coupling capacitance. If the capacitance value read is equal to the equivalent coupling capacitance, the value of spacing is selected. At step 608, if the capacitance value read is greater than the equivalent coupling capacitance, step 610 is performed; else, step 612 is performed. At step 610, the value of spacing is increased. At step 612, the value of spacing is decreased. Hence, the value of effective spacing is obtained.

Following this, the spacing between the pair of metal wires is changed to the effective spacing. While performing the change in spacing, it is ensured that the change in area capacitance is minimal. Area capacitance for a metal wire depends upon the area of the top view of the metal wire. In accordance with an embodiment of the present invention, width of rectangle 506 is changed to change the spacing between pair of rectangles 502 to the effective spacing. In another embodiment, width of rectangle 504 is changed. The changes in widths of rectangle 504 and rectangle 506 can be calculated as:

$$Δ W 504 = ( Sa - Se ) \frac{W 504}{W 504 + W 506}$$

$$Δ W 506 = ( Sa - Se ) \frac{W 506}{W 504 + W 506}$$

where,

W504 represents width of rectangle 504,

W506 represents width of rectangle 506,

ΔW504 represents the change in width of rectangle 504, and

ΔW506 represents the change in width of rectangle 506.

Thus, the widths of each of pair of rectangles 502 are adjusted to create a pair of reshaped wires placed at the effective spacing. The pair of reshaped wires created is electrically equivalent to pair of metal wires 102. The coupling capacitance associated with each of the pair of reshaped wires is same as that of the actual metal wires of the VLSI circuit design.

In accordance with an embodiment of the invention, the change in widths of rectangle 504 and rectangle 506 is zero and therefore, pair of rectangles 502 is same as the pair of reshaped wires.

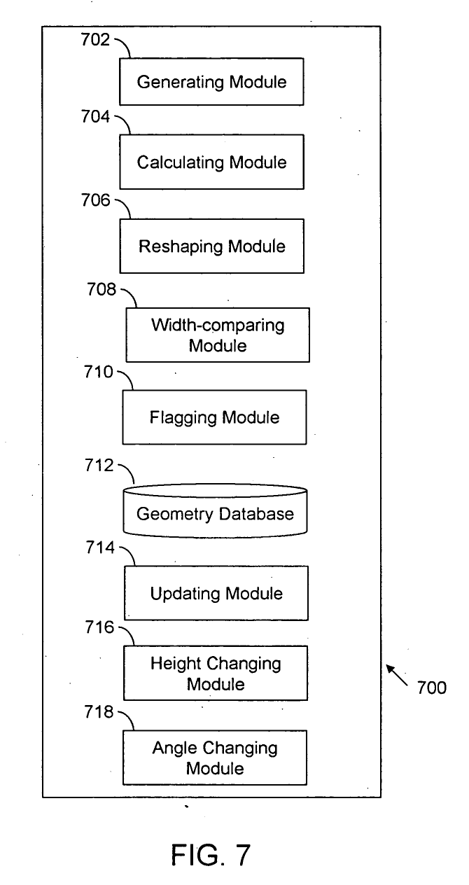

FIG. 7 illustrates a system 700 for reshaping pair of metal wires 102, in accordance with an embodiment of the invention. System 700 includes a generating module 702, a calculating module 704, a reshaping module 706. Generating module 702 represents sides of each of pair of metal wires 102 by a plurality of Piece Wise Linear (PWL) equations. Calculating module 704 calculates the equivalent coupling capacitance of pair of metal wires 102 using the plurality of PWL equations. Reshaping module 706 reshapes each of pair of metal wires 102 to form a pair of electrically equivalent reshaped wires. The pair of electrically equivalent reshaped wires has capacitance and resistance values equivalent to pair of metal wires 102.

In accordance with an embodiment of the present invention, system 700 includes a width-comparing module 708 and a flagging module 710. Width-comparing module 708 compares the widths of the pair of reshaped wires with the widths of an original pair of metal wires in a VLSI design. A difference in widths is calculated based on the comparison. Flagging module 710 flags at least one of the pair of reshaped wires if the difference in widths is more than a threshold value.

In accordance with another embodiment of the present invention, system 700 includes a Geometry Database (GD) 712 and an updating module 714. GD 712 stores data related to the shape of metal wires. For example, GD 712 can store the data in the form of coordinates of vertices of the polygons representing the metal wires. Updating module 714 adds the data corresponding to the pair of reshaped wires to GD 712. The addition of the data corresponding to the pair of reshaped wires to GD 712 ensures that the use of hash tables for tracking the pair of reshaped wires is not required.

In accordance with yet another embodiment of the present invention, system 700 further includes a height changing module 716 and an angle changing module 718. Height changing module 716 changes the height of pair of metal wires 102 to an actual value as in the original VLSI design for pair of metal wires 102. Similarly, angle changing module 718 changes the side wall angle of pair of metal wires 102 to an actual value of side wall angle. The changing of height and shape is explained later in conjunction with FIG. 11 and FIG. 12.

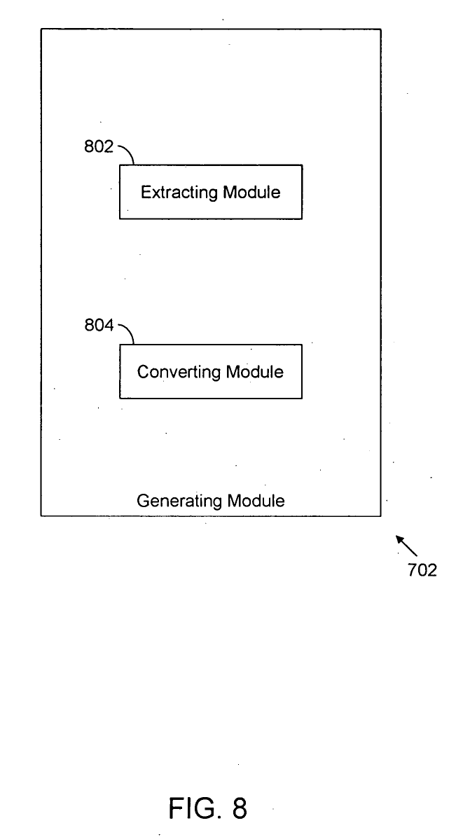

FIG. 8 is a block diagram illustrating generating module 702, in accordance with an embodiment of the invention. Generating module 702 includes an extracting module 802 and a converting module 804. Extracting module 802 extracts vertices of each of pair of metal wires 102 from GD 712. Converting module 804 transforms the vertices extracted into a plurality of Piece Wise Linear (PWL) equations. Extracting module 802 extracts vertices of metal wire 106 and metal wire 108 from GD 712. The vertices of metal wire 106 can be represented as (x₁, y₁, x₂, y₂, x₃, y₃, . . . , xₘ, yₙ), wherein the vertices have been represented in the co-ordinate form. Similarly, vertices of metal wire 108 can be represented as (x₁, y₁, x₂, y₂, x₃, y₃, xₙ, yₙ). Converting module 804 transforms the vertices (x₁, y₁, x₂, y₂, x₃, y₃, xₘ, yₙ) of metal wire 106 into a plurality of PWL equations of the form:
y=y₁+a₁(x−x₁);
y=y₂+a₂(x−x₂);
y=y₃+a₃(x−x₃); etc.
The values of a₁, a₂, and a₃ are given by:
a₁=(y₂−y₁)/(x₂−x₁);
a₂=(y₃−y₂)/(x₃−x₂);
a₃=(y₄−y₃)/(x₄−x₃); etc.

Each of the plurality of PWL equations represents a PWL section of metal wire 106. The plurality of PWL equations represents a PWL surface of metal wire 106. Similarly, PWL surface of metal wire 108 may be represented by a plurality of PWL equations.

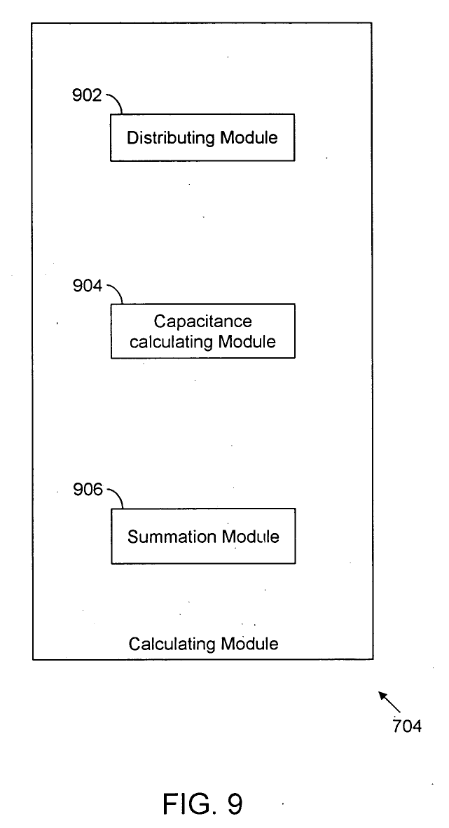

FIG. 9 is a block diagram illustrating calculating module 704, in accordance with an embodiment of the invention. Calculating module 704 includes a distributing module 902, a capacitance calculating module 904, and a summation module 906. Calculating module 704 calculates the equivalent coupling capacitance of pair of metal wires 102. Distributing module 902 divides pair of metal wires 102 into plurality of pair of PWL sections 304 as shown in FIG. 3. Capacitance calculating module 904 calculates coupling capacitances of each of plurality of pair of PWL sections 304. Summation module 906 adds the coupling capacitances of each of plurality of pair of PWL sections 304.

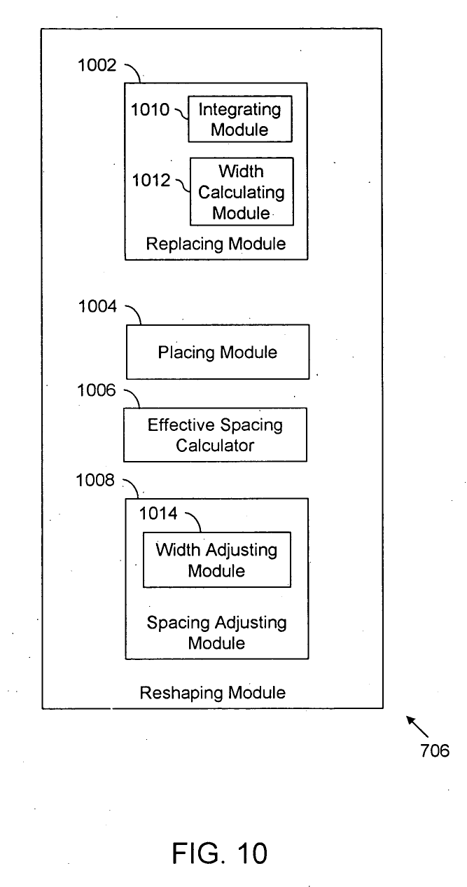

FIG. 10 illustrates a block diagram representing reshaping module 706, in accordance with an embodiment of the invention. Reshaping module 706 includes a replacing module 1002, a placing module 1004, an effective spacing calculator 1006, and a spacing adjusting module 1008. Replacing module 1002 further includes an integrating module 1010 and a width calculating module 1012. Also, Spacing adjusting module 1008 further includes a width adjusting module 1014.

Replacing module 1002 replaces pair of metal wires 102 by pair of rectangles 502 having areas equal to corresponding polygons as shown in FIG. 5. As the area of each of pair of rectangles 502 is equal to the corresponding polygons of each of the pair of metal wires 102, resistance and area capacitance of each of pair of rectangles 502 is equal to that of each of pair of metal wires 102. Integrating module 1102 integrates width of each of pair of metal wires 102 over length to calculate a corresponding area value. Width calculating module 1104 calculates a width of each of the pair of rectangles 502 by dividing the corresponding area value by the corresponding length of each of pair of metal wires 102.

Placing module 1004 places pair of rectangles 502 at the area average spacing. The area average spacing is the area average distance between pair of metal wires 102. Effective spacing calculator 1006 calculates the effective spacing corresponding to the equivalent coupling capacitance of pair of metal wires 102 using the lookup table.

Spacing adjusting module 1008 changes spacing between pair of rectangles 502 to the effective spacing. While performing change in spacing, spacing adjusting module 1008 ensures that the change in the area capacitance of each of pair of rectangles 502 is minimal. Width adjusting module 1010 adjusts widths of at least one of pair of rectangles 502 so that the spacing between pair of rectangles 502 is changed to the effective spacing. In accordance with an embodiment of the present invention, width adjusting module 1010 adjusts width of rectangle 506 to change the spacing between pair of rectangles 502 to the effective spacing. In another embodiment, width adjusting module 1010 adjusts width of rectangle 504. Width adjusting module 1010 uses the following relationship to determine the changes in widths of rectangle 504 and rectangle 506:

$$Δ W 504 = ( Sa - Se ) \frac{W 504}{W 504 + W 506}$$

$$Δ W 506 = ( Sa - Se ) \frac{W 506}{W 504 + W 506}$$

where,

W504 represents width of rectangle 504,

W506 represents width of rectangle 506,

ΔW504 represents the change in width of rectangle 504, and

ΔW506 represents the change in width of rectangle 506.

Thus, the widths of each of pair of rectangles 502 are adjusted to create a pair of reshaped wires placed at the effective spacing. The pair of reshaped wires created is electrically equivalent to pair of metal wires 102. The coupling capacitance associated with each of the pair of reshaped wires is the same as that of the actual metal wires of the VLSI circuit design.

In accordance with an embodiment of the present invention, a VLSI design on which OPC has been performed may have a plurality of metal wires. In such cases, to reshape the plurality of metal wires, a pair of adjacent wires out of the plurality of metal wires is considered at a time. The reshaping is done for the pair considered. Subsequently, the reshaping is done considering one of the reshaped wires and one of the metal wire from the remaining plurality of metal wires. Finally, a system level solution is obtained for the VLSI. The shapes of the reshaped wires are added to the GD. The GD can then be used to determine whether a metal wire has been reshaped in accordance with the invention or not. Reshaped wires are rectangular or smooth, whereas wires that are still to be reshaped are polygonal. This eliminates the requirement of hash tables to track which wires have been reshaped in the VLSI design.

FIG. 11 illustrates reshaping of metal wire 1102 having variable height, in accordance with an embodiment of the invention. Metal wire 1102 is obtained as a result of OPC and has a variable height and width. To obtain an electrically equivalent reshaped metal wire having orthogonal vertices corresponding to metal wire 1102, height of metal wire 1102 is changed to an actual height (H_{d}). The actual height is the modeled or target height of the original metal wire in the VLSI design. Metal wire 1104 represents metal wire 1102 with its height changed to H_{d}. The reshaping of metal wire 1104 is then carried out by performing the method steps of the invention as explained in conjunction with FIG. 2. After performing the method steps, the reshaped wire may be represented by reshaped wire 1106. The reshaped wire, thus obtained, is electrically equivalent to the original metal wire in the VLSI design and has orthogonal vertices.

FIG. 12 illustrates reshaping of metal wire 1202 having a variable side wall angle, in accordance with an embodiment of the invention. Metal wire 1202 has a variable side wall angle. To obtain an electrically equivalent reshaped metal wire (having orthogonal vertices) corresponding to metal wire 1202, the side wall angle of metal wire 1202 is changed to an actual side wall angle (SA_{d}). The actual side wall angle is the modeled or target angle of the original metal wire in the VLSI design. In an embodiment of the present invention, the value of SA_{d} is taken to be 90°. A 90° side wall angle ensures that the reshaped wires have orthogonal vertices. Metal wire 1204 represents metal wire 1102 with its side wall angle changed to SA_{d}. The reshaping can then be done by performing the method steps explained in conjunction with FIG. 2. After performing the method steps, the reshaped wire may be represented by reshaped wire 1206. The reshaped wire, thus obtained, is electrically equivalent to the original metal wire in the VLSI design and has orthogonal vertices.

The present invention represents the metal wires of a VLSI circuit in a simplified form by creating a pair of electrically equivalent reshaped metal wires having orthogonal vertices. RC extraction of the pair of reshaped metal wires representing the actual metal wires is easy and quick as each of the pair of reshaped metal wires has orthogonal vertices. Also, the present invention updates the GD by adding the data corresponding to the pair of reshaped wires to the GD. As a result of this, the pair of reshaped wires can be tracked without the use of hash tables. The pair of reshaped metal wires is compared with the original pair of metal wires in the VLSI design to determine if re-extraction is needed or not. Thus, the present invention enables RC extraction of metal wires in VLSI circuits after OPC, while reducing the effort and time required for the RC extraction.

The system, as described in the present invention, or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include Random Access Memory (RAM) and Read Only Memory (ROM). Computer system further comprises storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine. Exemplary storage elements include hard disk, DRAM, SRAM and EPROM. The storage element may also be external to the computer system, and connected to or inserted into the computer for download at or prior to the time of use. Exemplary of such external computer program products are computer readable storage mediums such as CD-ROMS, Flash chips, floppy disks, and the like.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program containing the set of instructions can be embedded in a computer program product for use with a computer, the computer program product comprising a computer usable medium having a computer readable program code embodied therein. The processing of input data by the processing machine may be in response to user commands, or in response to results of previous processing or in response to a request made by another processing machine.

While the foregoing is directed to embodiments of the present invention, other and further embodiments of the invention may be devised without departing from the basic scope thereof, and the scope thereof is determined by the claims that follow.

1. A method for simplifying the shape of a pair of metal wires, each of the pair of metal wires being used in Very Large Scale Integration (VLSI) circuits, the method comprising the steps of:
a. generating a plurality of Piece Wise Linear (PWL) equations representing sides of each of the pair of metal wires;
b. determining an equivalent coupling capacitance of the pair of metal wires using the plurality of PWL equations; and
c. reshaping each of the pair of metal wires to form a pair of reshaped wires, wherein the pair of reshaped wires is electrically equivalent to the pair of metal wires.

2. The method according to claim 1, further comprising the step of representing at least one of the pair of metal wires in the form of polygons.

3. The method according to claim 1 further comprising the step of changing height of at least one of the pair of metal wires to an actual height in a VLSI design.

4. The method according to claim 1 further comprising the step of changing side wall angle of at least one of the pair of metal wires to an actual side wall angle in a VLSI design.

5. The method according to claim 1 further comprising the step of calculating a difference between a width of at least one of the pair of reshaped wires and the width of at least one of an original pair of metal wires in a VLSI design.

6. The method according to claim 5, further comprising the step of flagging at least one of the pair of reshaped wires if the difference in width between at least one of the pair of reshaped wires and the width of at least one of the original pair of metal wires in the VLSI design is more than a threshold value.

7. The method according to claim 1 further comprising the step of updating a Geometry Database.

8. The method according to claim 1, wherein the step of generating the plurality of PWL equations comprises the steps of:
a. extracting vertices of each of the pair of metal wires from a Geometry Database (GD); and
b. converting the vertices to PWL equations.

9. The method according to claim 1, wherein the step of determining the equivalent coupling capacitance of the pair of metal wires using the plurality of PWL equations comprises the steps of:
a. dividing the pair of metal wires into a plurality of pair of PWL sections, each of the plurality of pair of PWL sections comprising a PWL section on each of the pair of metal wires;
b. determining coupling capacitances of each of the plurality of pair of PWL sections; and
c. summing the coupling capacitances of each of the plurality of pair of PWL sections.

10. The method according to claim 9, wherein the step of determining the coupling capacitances of each of the plurality of pair of PWL sections comprises the steps of:
a. dividing each of the plurality of pair of PWL sections into a plurality of pair of micro panels;
b. calculating micro coupling capacitances for each of the plurality of pair of micro panels using a lookup table; and
c. summing the micro coupling capacitances.

11. The method according to claim 1, wherein the step of reshaping each of the pair of metal wires to form a pair of electrically equivalent reshaped wires comprises the steps of:
a. replacing the pair of metal wires by a pair of rectangles having areas equal to corresponding metal wires;
b. placing the pair of rectangles at an area average spacing, the area average spacing being the area average distance between the pair of metal wires;
c. determining an effective spacing corresponding to the equivalent coupling capacitance of the pair of metal wires using a lookup table; and
d. changing spacing between the pair of rectangles to the effective spacing so that the change in area capacitance is minimal.

12. The method according to claim 11, wherein the step of replacing the pair of metal wires by a pair of rectangles having areas equal to corresponding metal wires comprises the steps of:
a. integrating width over length of each of the pair of metal wires to calculate a corresponding area value; and
b. dividing the corresponding area value by a corresponding length of each of the pair of metal wires.

13. The method according to claim 11 wherein the step of determining the effective spacing corresponding to the equivalent coupling capacitance of the pair of metal wires using the lookup table comprises the steps of:
a. reading a capacitance value corresponding to a value of spacing from the lookup table;
b. decreasing the value of spacing if the capacitance value corresponding to the value of spacing is greater than the equivalent coupling capacitance; and
c. increasing the value of spacing if the capacitance value corresponding to the value of spacing is less than the equivalent coupling capacitance.

14. The method according to claim 11, wherein the step of changing spacing between the pair of rectangles to the effective spacing so that the change in area capacitance is minimal comprises the step of adjusting widths of at least one of the pair of rectangles.

15. A system for simplifying the shape of a pair of metal wires, each of the pair of metal wires being used in Very Large Scale Integration (VLSI) circuits, the system comprising:
a. a generating module, the generating module representing sides of each of the pair of metal wires by a plurality of Piece Wise Linear (PWL) equations;
b. a calculating module, the calculating module determining an equivalent coupling capacitance of the pair of metal wires using the plurality of PWL equations; and
c. a reshaping module, the reshaping module changing shape of each of the pair of metal wires to form a pair of reshaped wires, wherein the pair of reshaped wires is electrically equivalent to the pair of metal wires.

16. The system according to claim 15, wherein each of the pair of metal wires is represented in the form of polygons.

17. The system according to claim 15 further comprising a height changing module, the height changing module changing height of at least one of the pair of metal wires to an actual height in a VLSI design.

18. The system according to claim 15 further comprising an angle changing module, the angle changing module changing the side wall angle of at least one of the pair of metal wires to an actual side wall angle in a VLSI design.

19. The system according to claim 15 further comprising a width-comparing module, the width-comparing module calculating a difference between a width of at least one of the pair of reshaped wires and the width of at least one of an original pair of metal wires in a VLSI design.

20. The system according to claim 15 further comprising a flagging module, the flagging module flagging at least one of the pair of reshaped wires if the difference in widths between at least one of the pair of reshaped wires and the width of at least one of the original pair of metal wires in the VLSI design is more than a threshold value.

21. The system according to claim 15 further comprising a Geometry Database (GD), the GD storing data corresponding to geometry of each of the pair of metal wires

22. The system according to claim 15 further comprising an updating module, the updating module adding the data corresponding to the pair of reshaped wires to a Geometry Database (GD).

23. The system according to claim 15, wherein the generating module comprises:
a. an extracting module, the extracting module extracts vertices of each of the pair of metal wires from a Geometry Database (GD); and
b. a converting module, the converting module transforming the vertices to Piece Wise Linear (PWL) equations.

24. The system according to claim 15, wherein the calculating module comprises:
a. a distributing module, the distributing module dividing the pair of metal wires into a plurality of pair of PWL sections, each of the plurality of pair of PWL sections comprising a PWL section on each of the pair of metal wires;
b. a capacitance calculating module, the capacitance calculating module determining coupling capacitances of each of the plurality of pair of PWL sections; and
c. a summation module, the summation module summing the coupling capacitances of each of the plurality of pair of PWL sections.

25. The system according to claim 24, wherein the capacitance calculating module comprises:
a. a dividing module, the dividing module dividing each of the plurality of pair of PWL sections into a plurality of pair of micro panels;
b. a micro capacitance calculating module, the micro coupling capacitance module calculating micro coupling capacitances for each of the plurality of pair of micro panels using a lookup table; and
c. a summation module, the summation module summing the micro coupling capacitances.

26. The system according to claim 15, wherein the reshaping module comprises:
a. a replacing module, the replacing module replacing the pair of metal wires by a pair of rectangles having areas equal to corresponding metal wires;
b. a placing module, the placing module placing the pair of rectangles at an area average spacing, the area average spacing being the area average distance between the pair of metal wires;
c. an effective spacing calculator, the effective spacing calculator determining an effective spacing corresponding to the equivalent coupling capacitance of the pair of metal wires using a lookup table; and
d. a spacing adjusting module, the spacing adjusting module changing spacing between the pair of rectangles to the effective spacing so that the change in area capacitance is minimal.

27. The system according to claim 26, wherein the replacing module comprises:
a. an integrating module, the integrating module integrating width over length of each of the pair of metal wires to calculate a corresponding area value; and
b. a width calculating module, the width calculating module calculating a width of each of the pair of rectangles by dividing the corresponding area value by a corresponding length of each of the pair of metal wires.

28. The system according to claim 26, wherein the spacing adjusting module comprises a width adjusting module, the width adjusting module being capable of adjusting widths of at least one of the pair of metal wires.

29. A computer program product for use with a computer, the computer program product comprising a computer usable medium having a computer readable program code embodied therein for simplifying the shape of a pair of metal wires, each of the pair of metal wires being used in Very Large Scale Integration (VLSI) circuits, the computer program code performing the steps of:
a. generating a plurality of Piece Wise Linear (PWL) equations representing sides of each of the pair of metal wires;
b. determining an equivalent coupling capacitance of the pair of metal wires using the plurality of PWL equations; and
c. reshaping each of the pair of metal wires to form a pair of reshaped wires, wherein the pair of reshaped wires is electrically equivalent to the pair of metal wires.

30. The computer program product of claim 29 further comprising a computer program code performing the step of representing at least one of the pair of metal wires in the form of polygons.

31. The computer program product of claim 29 further comprising a computer program code performing the step of changing height of at least one of the pair of metal wires to an actual height in a VLSI design.

32. The computer program product of claim 29 further comprising a computer program code performing the step of changing side wall angle of at least one of the pair of metal wires to an actual side wall angle in a VLSI design.

33. The computer program product of claim 29 further comprising a computer program code performing the step of calculating a difference between a width of at least one of the pair of reshaped wires and the width of at least one of an original pair of metal wires in a VLSI design.

34. The computer program product of claim 29 further comprising a computer program code performing the step of flagging at least one of the pair of reshaped wires if the difference in widths between at least one of the pair of reshaped wires and the width of at least one of the original pair of metal wires in the VLSI design is more than a threshold value.

35. The computer program product of claim 29 further comprising a computer program code performing the step of updating a Geometry Database (GD).

36. The computer program product of claim 29 wherein the computer program code performing the step of generating a plurality of PWL equations comprises computer program code performing the steps of:
a. extracting vertices of each of the pair of metal wires from a Geometry Database (GD); and
b. converting the vertices to PWL equations.

37. The computer program product of claim 29, wherein the computer program code performing the step of determining the equivalent coupling capacitance of the pair of metal wires comprises computer program code performing the steps of:
a. dividing the pair of metal wires into a plurality of pair of PWL sections, each of the plurality of pair of PWL sections comprising a PWL section on each of the pair of metal wires;
b. determining coupling capacitances of each of the plurality of pair of PWL sections; and
c. summing the coupling capacitances of each of the plurality of pair of PWL sections.

38. The computer program product of claim 37, wherein the computer program code performing the step of determining the coupling capacitances of each of the plurality of pair of PWL sections comprises computer program code performing the steps of:
a. dividing each of the plurality of pair of PWL sections into a plurality of pair of micro panels;
b. calculating micro coupling capacitances for each of the plurality of pair of micro panels using a lookup table; and
c. summing the micro coupling capacitances.

39. The computer program product of claim 29, wherein the computer program code performing the step of reshaping each of the pair of metal wires comprises computer program code performing the steps of:
a. replacing the pair of metal wires by a pair of rectangles having areas equal to corresponding metal wires;
b. placing the pair of rectangles at an area average spacing, the area average spacing being the area average distance between the pair of metal wires;
c. determining an effective spacing corresponding to the equivalent coupling capacitance of the pair of metal wires using a lookup table; and
d. changing spacing between the pair of rectangles to the effective spacing so that the change in area capacitance is minimal.

40. The computer program product of claim 39, wherein the computer program code performing the step of replacing the pair of metal wires by a pair of rectangles having equal area comprises computer program code performing the step of:
a. integrating width over length of each of the pair of metal wires to calculate a corresponding area value; and
b. dividing the corresponding area value by a corresponding length of each of the pair of metal wires.

41. The computer program product of claim 39 wherein the computer program code performing the step of determining the effective spacing corresponding to the equivalent coupling capacitance comprises computer program code performing the steps of:
a. choosing a value of spacing from a lookup table;
b. reading a capacitance value corresponding to the value of spacing; if the capacitance value corresponding to the value of spacing is greater than the equivalent coupling capacitance, performing steps c and b:
c. increasing the value of spacing; and else, performing steps d and b:
d. decreasing the value of spacing.

42. The computer program product of claim 39 wherein the computer program code performing the step of changing spacing between the pair of rectangles to the effective spacing so that the change in area capacitance is minimal comprises computer program code performing the step of adjusting widths of at least one of the pair of rectangles.
